(19) United States
(12) Patent Application Publication
(10) Pub. No.: US 2005/0235448 A1
(43) Pub. Date: Oct. 27, 2005

(54) Windshield wiper glove

(76) Inventor: Elizabeth Richard, Stoneham, MA (US)

Correspondence Address: FISH & RICHARDSON PC, P.O. BOX 1022, MINNEAPOLIS, MN, 55440-1022, US

(21) Appl. No.: 11/112,682

(22) Filed: Apr. 22, 2005

Related U.S. Application Data
(60) Provisional application No. 60/565,010, filed on Apr. 23, 2004.

(51) Int. Cl. B60S 1/04

(52) U.S. Cl. 15/257.01; 150/154; 15/250.001

(57) ABSTRACT

A windshield wiper glove constructed of waterproof and flexible material is designed to fit over and substantially cover a windshield wiper with the exception of the wiper arm. The glove serves the purpose of preventing the accumulation of snow, ice and other materials on the flexible portion of the windshield wiper so as to eliminate interference by these materials with the flexural movement of the wiper blade over a windshield, allowing a clean sweep of the windshield in inclement weather.

### TECHNICAL FIELD

This invention relates to windshield wipers for automobiles or other vehicles.

### BACKGROUND

One of the more critical problems confronting developers of windshield wipers utilizable to clean windshields of motor vehicles has been how to keep the wiper blades at all times in a close, conforming relationship with the windshield being cleaned. In this respect, snow, ice and sleet buildup on the wiper cause the wiper to lose flexibility so that only portions of the blade make contact with a windshield during a wiping operation. This of course results in the blade losing the ability to clean the windshield and the driver of the vehicle is then faced with problems of streaking on the windshield, which severely affect his visibility.

In an attempt to overcome these problems, developers have designed a number of different types of windshield wipers and extensions, all for use when the vehicle is in motion and the blades are in operation. In climates where a lot of snow is experienced, snow and ice cause the blades and extensions to temporarily warp out of shape, thereby pulling portions of a wiper blade completely away from a windshield. Effectively then, the use of these inventions in snow climates has not solved the issue of how to best keep the blade in contact with the window at all times. Further, none of the inventions are intended to only be used when the vehicle is stationary, thus improving wiper/windshield contact and visibility when the vehicle is in operation.

### SUMMARY

The present invention relates to windshield wipers such as those used on motor vehicles and more particularly pertains to a protective cover which may be fitted and secured over a windshield wiper, when the vehicle is not in use, so as to prevent the accumulation of snow and other materials within the flexural portion of the wiper.

In a general aspect of the invention, an apparatus includes a protective enclosure sized and shaped to receive a windshield wiper of a vehicle, the protective enclosure including a first section including a sealed portion, a second section having an opening for receiving the windshield wiper; and at least one fastening element attached to the second section and proximate the opening for securing the windshield wiper within the protective enclosure.

In another aspect of the invention, a method of making a windshield wiper protector of a vehicle comprises providing a protective enclosure sized and shaped to receive the windshield wiper, forming a sealed portion in the protective enclosure, forming an opening in the protective enclosure sized to receive the windshield wiper, the opening having a length less than a length of the windshield wiper; and providing at least one fastening element proximate the opening for securing the windshield wiper within the protective enclosure.

In still another aspect of the invention, a method of protecting a windshield wiper comprises providing a protective enclosure sized and shaped to receive the windshield wiper. The protective enclosure includes a sealed portion, an opening sized to receive the windshield wiper and having a length less than a length of the windshield wiper; and at least one fastening element proximate the opening. The method includes inserting a first end of the windshield wiper into the sealed portion through the opening; inserting the second, opposite end of the windshield wiper in the protective enclosure; and maintaining the windshield wiper within the protective enclosure using the fastening element.

Embodiments of this aspect of the invention may include one or more of the following features. The protective enclosure includes a flexible, waterproof material. The at least one fastening element is selected from the group consisting of a snap, hook and eye, drawstring, buckle, elastic, zip-lock seal, button or hook-loop fastener.

Among other advantages, the apparatus provides a windshield wiper cover that eliminates many of the problems associated with snow and ice buildup on a stationary vehicle that cause interference with the blade creating a clean sweep of the windshield. Basically, the glove prevents snow and other material from accumulating around the wiper while the vehicle is stationary. The cover is then removed prior to driving, allowing the vehicle to be put in motion without necessitating chipping and scraping ice from the wipers, possibly damaging them, while maintaining wiper flexibility and complete wiper/windshield contact for greater visibility.

It is therefore an object of the present invention to provide protection means for a windshield wiper.

It is another object of the present invention to provide a cover for a windshield wiper, which is effective in preventing the accumulation of snow and other materials about the flexural portion of the windshield wiper while the vehicle is stationary.

It is a further object of the present invention to provide a cover for a windshield wiper, which is effective in reducing the wear on the windshield wiper blade associated therewith.

An additional object of the present invention is to eliminate the windshield streaking associated with snow and ice buildup causing reduced visibility for the driver of the vehicle.

Yet another object of the present invention is to provide a cover for a windshield wiper, which may be economically and easily manufactured.

These together with other objects and advantages, which will become subsequently apparent reside in the details of construction and use as more fully hereinafter described and claimed. Reference being had to the accompanying drawings forming a pert hereof, wherein like numerals refer to like parts throughout.

The details of one or more embodiments of the invention are set forth in the accompanying drawings and the description below.

Other features, objects, and advantages of the invention will be apparent from the description and drawings, and from the claims.

### DESCRIPTION OF DRAWINGS

FIG. 1 is a perspective view of the unprotected windshield wiper attached to a motor vehicle.

FIG. 2 is a perspective view of the wiper glove secured over the windshield wiper on a vehicle.

FIG. 3 is a view of the standalone wiper glove illustrating opening and fastener placement.

FIG. 4 is a side view of the standalone wiper glove securely fastened over a windshield wiper.

### DETAILED DESCRIPTION

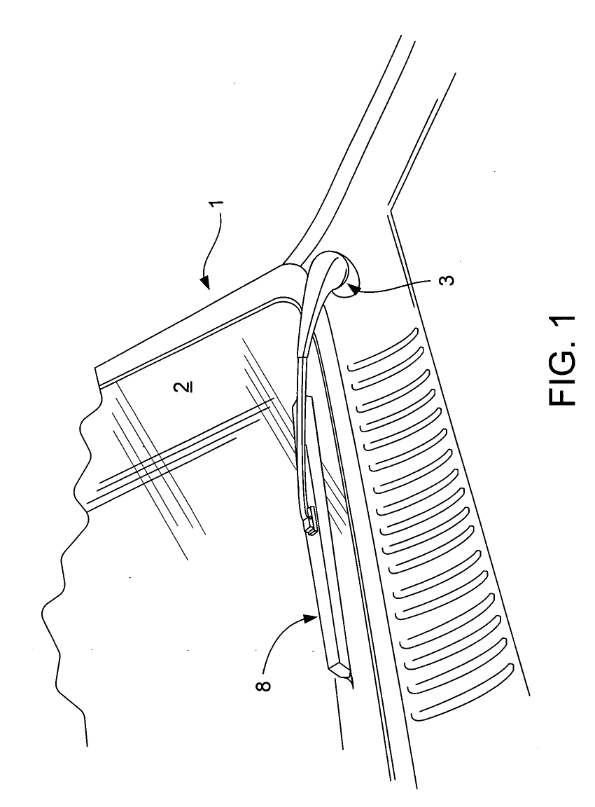

Reference is now made to the drawings and, in particular, to FIG. 1 wherein there is illustrated in detail a motor vehicle 1 having a windshield 2 over which is slidably movable a windshield wiper 3 arm attached to the vehicle, and flexural portion of the wiper 8 which sweeps the windshield while in operation.

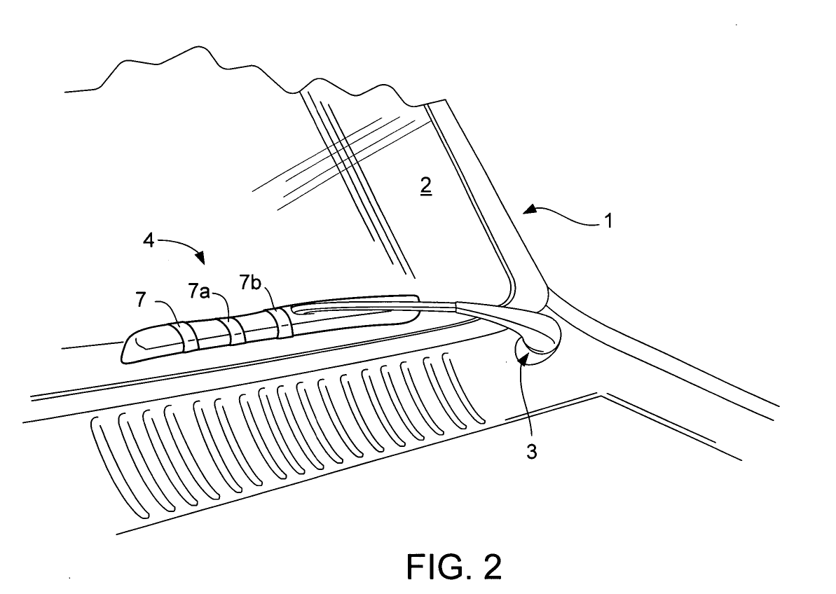

With reference to FIG. 2, note illustration of motor vehicle 1, windshield 2, windshield wiper 3 and the presence of the wiper glove 4 over the flexural portion of the wiper 8.

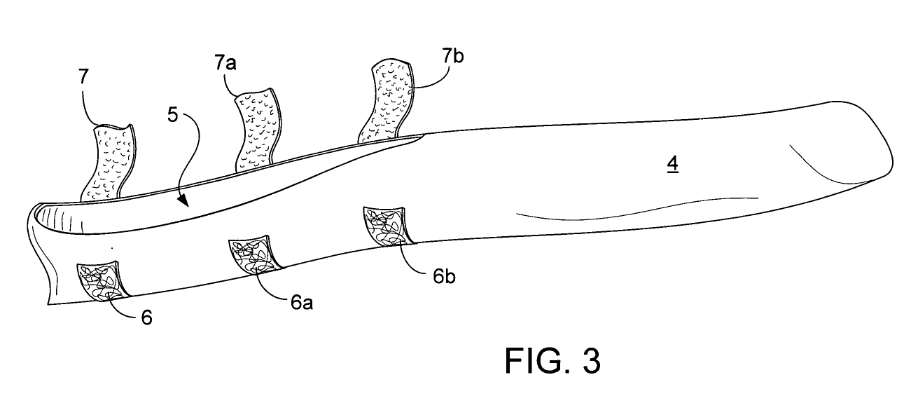

FIG. 3 illustrates an external view of the glove 4, the opening 5 in which to insert the flexural portion of the wiper blade 8, fasteners 6, 6a, 6b and 7, 7a, 7b with which to secure the glove to the flexural portion of the wiper blade 8.

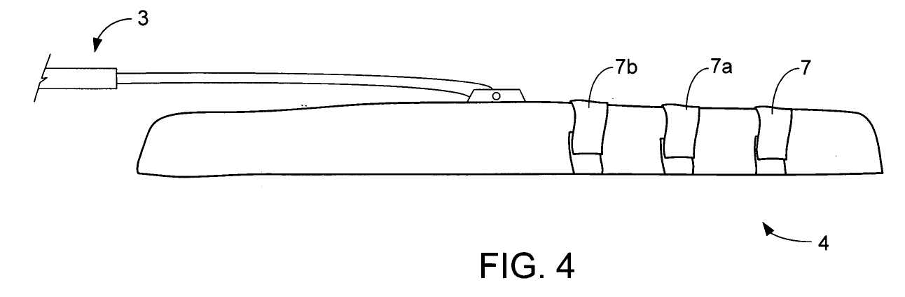

FIG. 4 illustrates the wiper arm 3, and wiper glove 4 securely fastened over the flexural portion of the wiper 8.

Turning now to the construction of the present invention, the wiper glove 4 is constructed of waterproof, flexible material (e.g., Tyvek®, a registered trademark of E.I. du Pont de Nemours and Company, Wilmington, Del.), sewn leaving an opening 5 long enough to slide one end of flexural portion of the wiper 8 into. The remaining end of the flexural portion of the wiper 8 is covered with the wiper glove 4 end with the fasteners 6, 7. Securely fastening the glove 4 to the wiper 8 may be achieved by several means. Fasteners 6, 7 could be made of plastic or metal snaps, hook and eye, drawstring, buckle, elastic, zip-lock seal, button/button hole or hook and loop fastener (e.g., Velcro®, a registered trademark of Velcro Industries B.V.). The fastener 6, 7 would preferably be of industrial grade, and attached to the glove 4 in a fashion that would prevent them from detaching themselves from the glove 4 in inclement weather. For illustration purposes of FIG. 2, FIG. 3 and FIG. 4, we have used Velcro. Successful attachment of the glove 4 to the windshield wiper 8 will result in complete protection from the outside environment for the wiper 8 preventing snow, sleet or ice buildup on the flexural portion of the wiper blade 8. Prior to operating the vehicle 1, windshield 2 is completely cleaned and defrosted by the operator, glove 4 is removed from the windshield wiper 8, wiper 3 is put in operation and achieves a clean sweep of windshield 2 while the vehicle 1 is in operation.

Wiper glove 4 could be constructed of flexible, waterproof material and does not freeze. The glove 4 would be manufactured in several sizes to accommodate many different models of domestic and imported vehicles. The glove 4 would be placed on the vehicle 1 by lifting the flexural portion of the wiper 8 from the windshield 2 at the bending mechanism on the wiper 3. The glove 4 would be placed over the wiper 8 by inserting one end of the wiper 8 into the opening 5 of the glove 4 as far as possible. The then exposed half of the wiper 8 would be covered with the remaining half of the glove 4. One side of the opening 5 of the glove 4 would be folded over the wiper blade 8, and secured by attaching fastener 7b to 6b, then 7a to 6a and finally 7 to 6. If done properly, there is now complete coverage of the wiper blade 8. The wiper blade 8 can now be placed back on the windshield 2 by operating the bending mechanism on the wiper 3. The glove 4 is left in place while the vehicle is not in operation.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

A number of embodiments of the invention have been described. Nevertheless, it will be understood that various modifications may be made without departing from the spirit and scope of the invention. Accordingly, other embodiments are within the scope of the following claims.

1. An apparatus comprising:
a protective enclosure sized and shaped to receive a windshield wiper of a vehicle, the protective enclosure including:
a first section including a sealed portion,
a second section having an opening for receiving the windshield wiper; and
at least one fastening element attached to the second section and proximate the opening for securing the windshield wiper within the protective enclosure.

2. The apparatus of claim 1 wherein the protective enclosure comprises a flexible material.

3. The apparatus of claim 1 wherein the protective enclosure comprises a waterproof material.

4. The apparatus of claim 1 wherein the at least one fastening element is selected from the group consisting of a snap, hook and eye, drawstring, buckle, elastic, zip-lock seal, button or hook-loop fastener.

5. A method of making a windshield wiper protector of a vehicle, the method comprising:
providing a protective enclosure sized and shaped to receive the windshield wiper;
forming a sealed portion in the protective enclosure,
forming an opening in the protective enclosure sized to receive the windshield wiper, the opening having a length less than a length of the windshield wiper; and
providing at least one fastening element proximate the opening for securing the windshield wiper within the protective enclosure.

6. The method of claim 5 further comprising forming the protective enclosure with a flexible material.

7. The method of claim 5 wherein forming the protective enclosure with a waterproof material.

8. The method of claim 5 wherein the at least one fastening element is selected from the group consisting of a snap, hook and eye, drawstring, buckle, elastic, zip-lock seal, button or hook-loop fastener.

9. A method of protecting a windshield wiper comprising:
providing a protective enclosure sized and shaped to receive the windshield wiper, the protective enclosure including:
a sealed portion,
an opening sized to receive the windshield wiper and having a length less than a length of the windshield wiper; and
at least one fastening element proximate the opening
inserting a first end of the windshield wiper into the sealed portion through the opening;
inserting the second, opposite end of the windshield wiper in the protective enclosure; and
maintaining the windshield wiper within the protective enclosure using the fastening element.
